(19) United States
(12) Patent Application Publication
(10) Pub. No.: US 2020/0364733 A1
(43) Pub. Date: Nov. 19, 2020

(54) SYSTEM AND METHODS FOR NETWORK MARKETING COMPENSATION

(71) Applicants: Surasak BAMRUNGWONG, Chon Buri (TH); Mayuree BAMRUNGWONG, Chon Buri (TH); Sarandhorn BAMRUNGWONG, Chon Buri (TH); Saravis BAMRUNGWONG, Chon Buri (TH)

(72) Inventors: Surasak BAMRUNGWONG, Chon Buri (TH); Mayuree BAMRUNGWONG, Chon Buri (TH); Sarandhorn BAMRUNGWONG, Chon Buri (TH); Saravis BAMRUNGWONG, Chon Buri (TH)

(21) Appl. No.: 15/901,922

(22) PCT Filed: Nov. 22, 2017
(86) PCT No.: PCT/TH2017/000083

§ 371 Date: Feb. 22, 2018

(51) Int. Cl. G06Q 30/02; G06Q 10/06; G06F 17/11

(52) U.S. Cl. CPC G06Q 30/0214; G06Q 30/0211; G06F 17/11; G06Q 10/067; G06Q 30/0282

(57) ABSTRACT

The present invention relates generally to network marketing compensation, and specifically to a system and methods to compensate IBOs in a multi-level marketing program based on real business production performed by IBOs, by using definite specification methods, definite computation methods with compensation formulas, or specific techniques, to identify or determine Business Post, Leg Point, Depth Point and Business Scores, to calculate bonuses or other benefits in a compensation plan. A traditional stair-step and break-away plan is used as a starting point of improvements and is developed to be a new “team-up” compensation plan in this invention. Solutions of significant technical problems are disclosed.

### TECHNICAL FIELD

This invention relates generally to network marketing compensation and more specifically to a system and methods to compensate customers or distributors or independent business owners, enrolled or sponsored in network marketing or multi-level marketing programs by using production-based criteria to reward Business Post bonus, Depth Point bonus and/or Business Scores bonus.

### BACKGROUND ART

Network marketing involves direct selling or retail customer referral programs. A customer may, at the same time, become an independent distributor or independent business owner, hereinafter called: IBO; enrolled in a network marketing or multi-level marketing program and earn commissions, bonuses, and/or other benefits from a multi-level compensation plan. At present, millions of people around the world have involved in this industry.

IBOs purchase products/services at a discount, and may use the products by themselves or resell them. Furthermore, IBOs may refer or sponsor other people, called downline, and help them do the same by selling products and/or building network of consumers/direct sellers. They may also help downline sponsor next downline in the next levels and expand business by working together as a team.

Compensations are paid to IBOs in the manner of multi-level payouts according to business production they performed. Whereas, compensation plans actually are quite complicated as concerning with multiple levels and many people are involved. At present, compensation methods are diversified into many types and plans. In practice, it was found that, there are still some technical problems to be solved.

### SUMMARY OF THE INVENTION

In this invention, compensation type of “stair-step and break-away” is used as a starting point of improvements and is developed to be a new “team-up” plan instead, by changing concept of “breaking away” which induces breakage, to be a new concept of “teaming up” which is meaningful in both compensation methods or also in its sense of working together as a team.

In other words, “Team-up” means: Together everyone achieves more ultimate plan. In this invention, methods of payouts are improved to be real fairness according to real business production they did.

### Technical Problems and Solutions

In the traditional plans, compensation methods still have some challenges, such as: lack of suitable methods to correlate or balance of payouts between width and depth businesses, and to compensate depth business with a suitable control of total payout budgets. More specifically, some parts of payout methods induce conflicts among IBOs within the same line of sponsorship.

In imperfect plans, imbalanced payouts induce three kinds of relationship among upline and downline IBOs, these are: supportive, non-supportive and conflict. Improved methods of this invention eliminate two kinds of those negatives: non-supportive and conflict, and promote team working among them.

The improvements overcome all said technical problems, including: methods of a well-balance or correlation between width and depth businesses, methods of justified compensation according to depth business, and to prevent overflow of total payouts for limitless growth of real business, as well as methods to avoid conflicts within the same line of sponsorship due to imbalanced compensations.

For international and foster sponsor business or cross-structure business, methods to determine bonuses across business structures are also disclosed.

### Industrial Applicability and Advantageous Effects of the Invention

By solving said technical problems, it is firmly believed that the improvements could be applied and much benefit to network marketing industry as a whole. It is encouraged to standardize compensation plans by the uses of this invention. Furthermore, it is expected that, as a fair or fine compensation system of the embodiment, it shall help uplift confidence of network marketing spirit or philosophy, and accelerate its role in the marketing systems.

### BRIEF DESCRIPTION OF THE DRAWINGS

FIG. 1 is a flowchart of a data processing with brief steps to determine compensations for an IBO in a network marketing program.

FIG. 2 is a flowchart to determine Leg Point (LP) of a qualified leg.

FIG. 3 is a flowchart to determine Business Post (BP).

FIG. 4 is a flowchart to determine Depth Point (DP).

FIG. 5 is a flowchart to determine Business Scores (BS).

FIG. 6 shows overall compensations to be paid to IBOs.

FIG. 7 shows exemplary methods of definite specifications of B1 and S1.

FIG. 8 shows exemplary methods of definite specifications of B2 and S2.

FIG. 9 shows an exemplary method of definite specification of M1.

FIG. 10 shows an exemplary method of definite specification of M3.

FIG. 11 shows a mid-qualification of M4, as a calculated result of two qualified legs when BP is less than one.

FIG. 12 shows an exemplary calculated result of B1 with two qualified legs.

FIG. 13 shows another exemplary calculated result of B1 with two qualified legs of B1.

FIG. 14 shows two levels of 1-point qualifications of B1 and S1 in a qualified leg.

FIG. 15 shows another two levels of 1-point qualifications of B1 and S1, with a notice that, M2, or any pre-qualification or mid-qualification, is not counted as a level of 1-point qualification in a qualified leg.

FIG. 16 shows two levels of 2-point qualifications of B2, with a notice that, S1 is not counted as a level in a B2-leg.

FIG. 17 shows four levels of 2-point qualifications of B2 and above, with a notice that, B3 is counted as a level in a B2-leg, but it is used only as a 2-point qualification in that level when it is calculated as in a B2-leg.

FIG. 18 shows an exemplary modified method of definite specification of S1, when an international leg is calculated as a half of Leg Point (LPᵢₙₜₑᵣ=½).

FIG. 19 shows an exemplary modified method of definite specification of B1, when an international leg is calculated as a half of Leg Point (LPᵢₙₜₑᵣ=½).

FIG. 20 shows another exemplary modified method of definite specification of B1, when an international leg is calculated as one Leg Point (LPᵢₙₜₑᵣ=1).

FIG. 21 shows an exemplary modified calculated result of B1, when an international leg is calculated as one Leg Point (LPᵢₙₜₑᵣ=1).

FIG. 22 shows exemplary international sponsor leg and foster sponsor leg in a domestic or local structure.

FIG. 23 shows three levels of mid-qualifications of M3 and M4 in a qualified leg.

FIG. 24a shows an exemplary business structure of a traditional compensation system (prior art) for a comparison with the present improvements in FIG. 24b.

FIG. 24b shows an exemplary business structure of the preferred embodiment with the same genealogy and business sizes compared to those in FIG. 24a.

### DETAILED DESCRIPTION OF THE INVENTION

To compensate IBOs in a network marketing program, FIG. 6 shows overall compensations 601 to be paid to IBOs who are eligible for. In some parts, traditional performance bonus 602, leadership bonus 603 or some other bonuses 604 are applied by the same ways used in the traditional plans.

For improvements, the present invention introduces new terms or definitions of Business Post (BP), Leg Point (LP), Depth Point (DP) or Business Scores (BS), and used as bases for further calculation of the new invented bonuses.

### Calculation of Compensations and Bonuses

Beyond traditional bonuses mentioned above, new bonuses are identified as: Business Post bonus 605, BPB=r₁ BP; Depth Point bonus 606, DPB=r₂ DP and Business Scores bonus 607, BSB=r₃ BS; where: r₁, r₂ and r₃ are payout rates. For further annual bonuses or other benefits such as some specific awards or incentives may also be calculated, based on BP, LP, DP or BS.

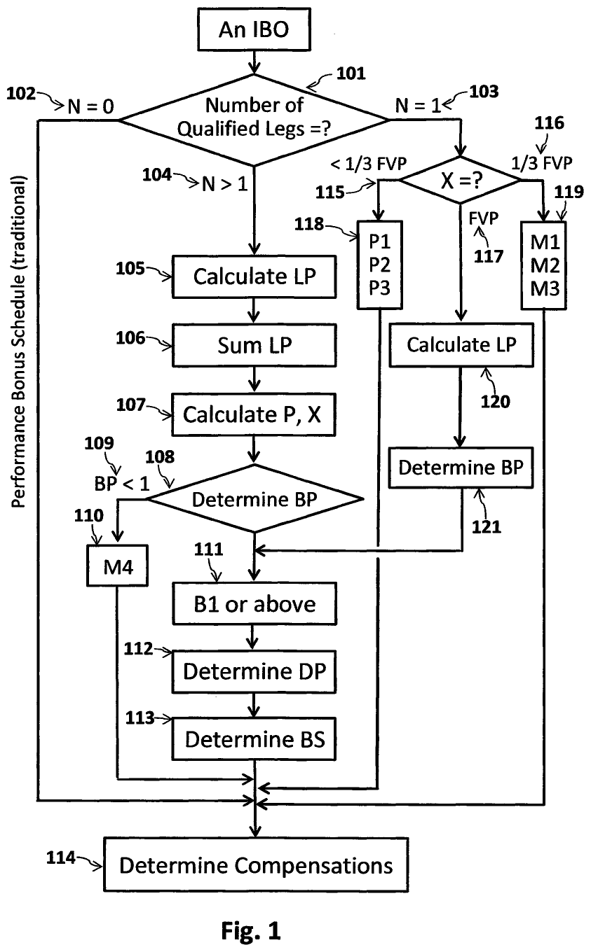

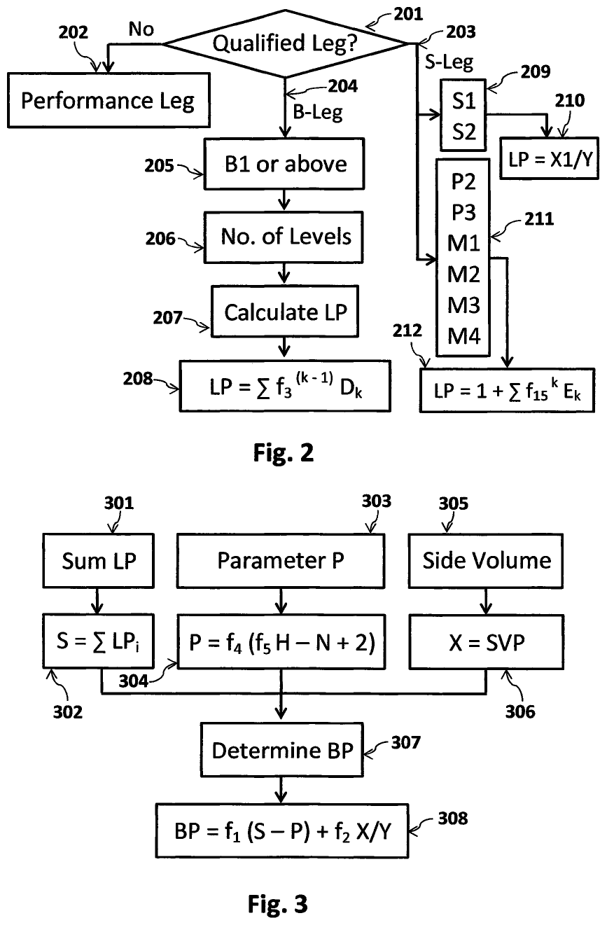

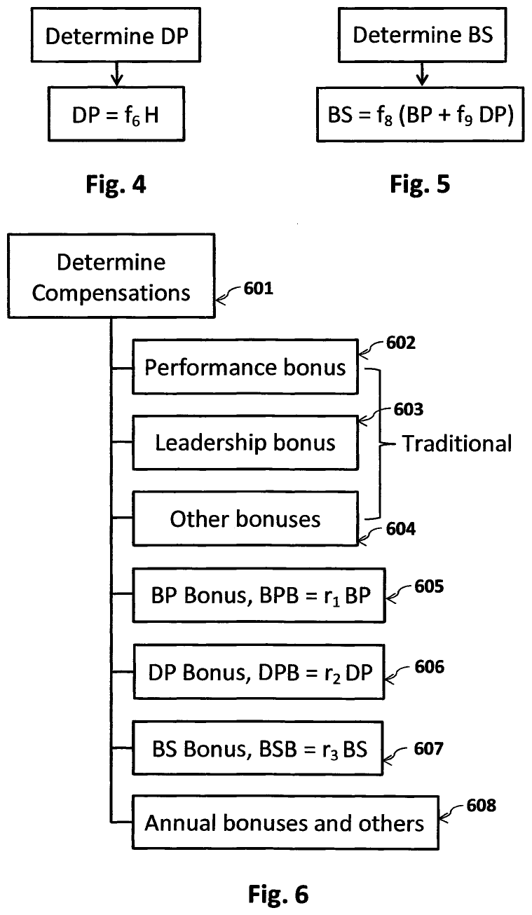

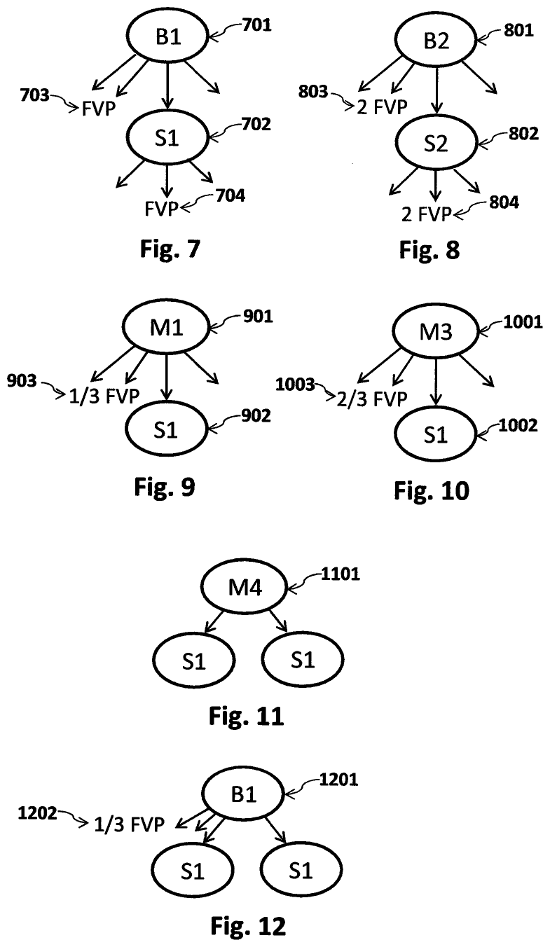

FIGS. 1 to 5 are data processing flowcharts with brief steps or methods to determine compensations for IBOs who are eligible for. In the processing, an IBO's business may be classified into three categories 101 as shown in FIG. 1. These are: (i) an IBO with no qualified leg 102, (ii) an IBO who attains one qualified leg 103, or (iii) an IBO who attains two qualified legs or more 104.

To determine compensations, for an IBO with no qualified leg, traditional performance bonus is applied. For an IBO who attains one qualified leg, methods of definite specification are primarily applied with the help of some calculation methods. And for an IBO who attains two qualified legs or more, methods of definite computation with specific compensation formulas are applied. Traditional leadership bonus (or override commission) 603 is applied for qualifiers who sponsor of at least one qualified leg.

For further details, methods to identify or determine BP, LP, DP or BS are disclosed with definite specifications or compensation formulas, as followings:

### Definite Specifications

Definite specifications of the embodiment, that satisfy the conditions in a corresponding business production period, comprising:

[Spec. 1] Business Post (BP) of an IBO is definitely specified as a unit of business size, in the form of rounding-down integer, identified or determined by methods of definite specification, or also further determined by methods of definite computation with specific compensation formulas [Math. 1]. An IBO who achieves 1 BP qualifies as B1, 2 BP qualifies as B2, or so on, correspondingly.

[Spec. 2] Business Post of one (1 BP or B1), of an IBO 701, is definitely specified as an achievement of sponsoring at least a qualified leg of S1 702 or above, and attaining side volume PV of at least a full volume PV 703. B1 is a significant post like the first pillar in a business structure of network marketing.

[Spec. 3] Business Post of two (2 BP or B2), or above, of an B30 801, is definitely specified as an achievement of sponsoring at least a qualified leg of S2 802, or B2, or above, and attaining side volume PV of at least two times of full volume PV 803, or above, correspondingly.

[Spec. 4] Leg Point (LP) of a qualified leg is definitely specified as calculated point of leg size, determined by specific compensation formulas [Math. 3] or other specified methods.

[Spec. 5] Depth Point (DP) of an IBO is definitely specified as calculated point of business depth, determined by specific compensation formulas [Math. 5] with conditions.

[Spec. 6] Business Scores (BS) of an IBO is definitely specified as a unit of business with depth inclusive, determined by specific compensation formulas [Math. 6].

[Spec. 7] S1 702 is definitely specified as a base qualification of an IBO who achieves group volume PV of at least a full volume PV 704. S1 is counted as a base point of at least one point.

[Spec. 8] S2 802, or above, is definitely specified as a base qualification of an IBO who achieves group volume PV of at least two times of full volume PV 804, or above, excluding qualified leg(s), if any. S2, or above, is counted as at least two base points, or above, correspondingly.

[Spec. 9] P1 118 is definitely specified as a pre-qualification of an IBO who sponsors a qualified leg of S1 or above.

[Spec. 10] P2 is definitely specified as a pre-qualification of an IBO who sponsors a qualified leg of S1 or above, and attains side volume PV (excluding the qualified leg) of at least one-twelfth of full volume PV. Equivalent side volume PV fractions or Eₖ of P2 is 1/12.

[Spec. 11] P3 is definitely specified as a pre-qualification of an IBO who sponsors a qualified leg of S1 or above, and attains side volume PV of at least one-sixth of full volume PV. Equivalent side volume PV fractions or Eₖ of P3 is ⅙.

[Spec. 12] M1 901 is definitely specified as a mid-qualification of an IBO who sponsors a qualified leg of S1 or above, and attains side volume PV of at least one-third of full volume PV 903. Equivalent side volume PV fractions or Eₖ of M1 is ⅓.

[Spec. 13] M2 is definitely specified as a mid-qualification of an IBO who sponsors a qualified leg of S1 or above, and attains side volume PV of at least a half of full volume PV. Equivalent side volume PV fractions or Eₖ of M2 is ½.

[Spec. 14] M3 1001 is definitely specified as a mid-qualification of an B30 who sponsors a qualified leg of S1 or above, and attains side volume PV of at least two-thirds of full volume PV 1003. Equivalent side volume PV fractions or Eₖ of M3 is ⅔.

[Spec. 15] M4 1101 is definitely specified as a mid-qualification of an IBO who sponsors two qualified legs of S1 or above, but not yet achieves B1 qualification or above. Equivalent side volume PV fractions or Eₖ of M4 is ⅔.

[Spec. 16] Group volume PV (GVP) is definitely specified as a total PV of personal group including personal PV, of an IBO.

[Spec. 17] Side volume PV (SVP or X) is definitely specified as a total PV of personal group including personal PV, but excluding qualified leg(s), of an IBO.

[Spec. 18] Full volume PV (FVP or Y) is definitely specified as a full volume PV that qualifies the maximum performance bonus level [Table 0001].

[Spec. 19] Qualified leg is definitely specified as a business leg of an IBO, attaining at least a full volume PV, or a leg of attaining S1 or above, or a leg of at least one Leg Point.

[Spec. 20] Performance leg is definitely specified as a business leg of an IBO, attaining PV but not yet a full volume PV.

[Spec. 21] S-leg is definitely specified as a business leg of an IBO, attaining at least S1 qualification, but not yet B1 or above. Leg Point 210 of S-leg is definitely specified as X1/Y; where: X1 is group volume PV of S1 or above, and Y is a full volume PV of performance bonus schedule.

[Spec. 22] B-leg is definitely specified as a business leg of an IBO, attaining at least B1 qualification. Leg Point of B-leg is determined by specific compensation formulas [Math. 3].

[Spec. 23] Leg Point of a qualified leg with pre-qualifications of P2, P3 or mid-qualifications of M1, M2, M3 or M4, is determined by an extra formula [Math. 16].

[Spec. 24] International sponsor leg 2204 is definitely specified as a business leg of an IBO, internationally sponsored to another country or across to another structure and a business is built in local or domestic market under a foster sponsor's genealogical structure.

[Spec. 25] Foster sponsor leg 2205 is definitely specified as a local or domestic business leg of an IBO, internationally sponsored from another country or across from another structure and a business is built in local or domestic market under a foster sponsor's genealogical structure.

[Spec. 26] Number of qualified legs (N) is definitely specified as number of all qualified legs, or legs of at least one Leg Point, of an IBO.

### Specific Compensation Formulas

Methods of definite computation by using specific compensation formulas, that satisfy the conditions in a corresponding production period, are disclosed herein, comprising:

[Math. 1] Business Post of an IBO, in rounding-down integer,

BP=f₁(S−P)+f₂X/Y;

[Math. 2] Sum of Leg Points of all qualified legs,

S=ΣLPᵢ=LP₁+LP₂+LP₃+ . . . i=1,2,3, . . . ;

[Math. 3] Leg Point of a qualified leg,

LP=Σf₃^{(k-1)}Dₖ k=1,2,3, . . . ;

[Math. 4] Parameter,

P=f₄(f₅H−N+2);

[Math. 5] Depth Point of an IBO,

DP=f₆H;

[Math. 6] Business Scores of an IBO,

BS=f₈(BP+f₉DP);

where:

BP is Business Post of an IBO, in rounding-down integer;

DP is Depth Point of an IBO, DP< or =f₇BP, if DP>f₇BP, let DP=f₇BP;

BS is Business Scores of an IBO;

S is sum of LP of all qualified legs of an IBO;

LP is Leg Point of each qualified leg, LP; =LP₁, LP₂, LP₃ . . . of legs #1, #2, #3 . . . , respectively; it is noted that, if it could be calculated with several options in a qualified leg, the highest calculated point is identified as Leg Point.

Dₖ is Business Post or base point of the same point or above, of each level in the same line in depth, all Dₖ used in calculation are the same, i.e., Dₖ=D₁=D₂=D₃ . . . , in levels #1, #2, #3 . . . , respectively.

P is Parameter, P= or >0, if P<0, let P=0.

H is the highest Leg Point of the largest leg of an IBO as calculated.

N is number of qualified legs of an IBO, N is used in calculation when two legs or more are qualified.

X is side volume PV (SVP), of an IBO, excluding qualified leg(s).

Y is full volume PV (FVP) of performance bonus schedule.

f₁, f₂, f₃, f₄, f₅, f₆, f₇, f₈ and f₉ are control factors, based on specific purpose of the program.

### Modified Compensation Formulas

For international and foster sponsor business (FIG. 22) or cross-structure business, international business factor (fᵢₙₜₑᵣ) and foster business factor (f_{foster}) are applied. In this case, full volume BV (FVB) of the performance bonus schedules [Table 0001] between international markets or cross structures should be equivalent in worth, or else, adjustment factors may be needed, or other factors may also be included. The modified formulas, comprising:

| | |
|---|---|
| [Math. 7] Leg Point of a foster leg, | LP_{foster} = f_{foster} LP; |
| [Math. 8] Leg Point of an international leg, | LPᵢₙₜₑᵣ = f₁₀ fᵢₙₜₑᵣ LP; |
| [Math. 9] Business Post of a foster leg, | BP_{foster} = f_{foster} BP; |
| [Math. 10] Business Post of an international leg, | BPᵢₙₜₑᵣ = f₁₁ fᵢₙₜₑᵣ BP; |
| [Math. 11] Depth Point of a foster leg, | DP_{foster} = f_{foster} DP; |
| [Math. 12] Depth Point of an international leg, | DPᵢₙₜₑᵣ = f₁₂ fᵢₙₜₑᵣ DP; |
| [Math. 13] Business Scores of a foster leg, | BS_{foster} = f_{foster} BS; |
| [Math. 14] Business Scores of an international leg, | BSᵢₙₜₑᵣ = f₁₃ fᵢₙₜₑᵣ BS; |

where: fᵢₙₜₑᵣ is international business factor, f_{foster} is foster business factor; f₁₀, f₁₁, f₁₂ and f₁₃ are adjustment factors, based on specific purpose of the program.

It is recommended, but not a limitation, to start sharing Leg Point between international and foster sponsors when the calculated Leg Point of foster sponsor portion [Math. 7] becomes at least one point (LP_{foster}=1), as when it is less than one point, it could not be calculated as a qualified leg. This means it is advised, in the preferred embodiment, to start sharing Leg Point from a qualified leg of at least B1, of domestic or local market.

On international sponsor portion, to calculate with Leg Point of international leg (LPᵢₙₜₑᵣ) 2204, it is suggested to match with a qualifier of S1 or above. In the case if the calculated LPᵢₙₜₑᵣ is less than one point, it is not calculated as a qualified leg in the calculation on the international sponsor portion. Therefore, a compensation formula is modified as shown, herein:

[Math. 15] Business Post,

BP=f₁(S−P)+f₂X/Y+f₁₄LPᵢₙₜₑᵣ;

where:

LPᵢₙₜₑᵣ<1 and f₁₄ is an adjustment factor.

Extra Techniques with Extra Formula

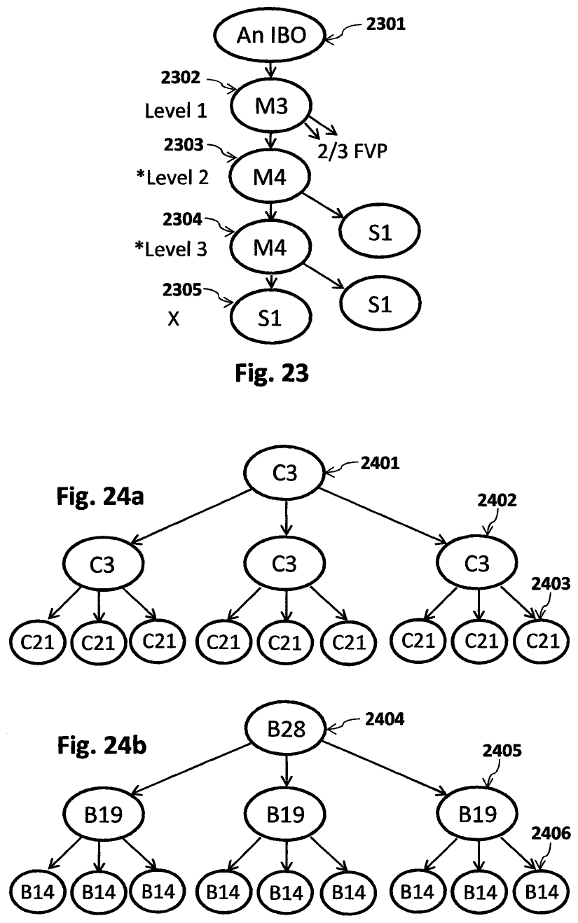

To calculate Leg Point of a qualified leg 211 with pre-qualifications of P2, P3 or mid-qualifications of M1, M2, M3 or M4 (FIG. 23), extra techniques are disclosed with an extra formula, herein:

[Math. 16] Leg Point,

LP=1+Σf₁₅^{k}Eₖ;

where: Eₖ is equivalent side volume PV fractions of pre-qualifications or mid-qualifications, in each levels in the same line in depth of the same fractions or above, by using the same fractions in calculation, i.e.: Eₖ=E₁=E₂=E₃ . . . , in levels #1, #2, #3 . . . , respectively, and f₁₅ is a control factor.

### BEST MODE FOR CARRYING OUT THE INVENTION

The examples shown in the preferred embodiment, herein, are considered as the best mode, and therefore, are not considered as a limitation of the invention.

In an exemplary traditional program of some large companies in this industry, a compensation plan may comprise: (i) monthly bonuses, such as: performance bonus, ruby bonus, leadership bonus, depth bonus; or (ii) annual bonuses, such as: emerald bonus, diamond bonus, diamond plus bonus, profit sharing bonus, founders achievement awards, or other benefits or incentives.

Payout calculation methods of such traditional plans can generally be found, so are not mentioned herein. The following is an exemplary performance bonus schedule, for a production period, which is used as a starting point in the examples of the embodiment, but is not a limitation. Performance bonus schedules may be diversified with different programs or different markets.

TABLE 0001
Exemplary Performance Bonus Schedule (traditional)

| PV (Point Value) | Bonus (% of BV) |
|---|---|
| 150,000 or more | 25% |
| 100,000-149,999 | 21% |
| 75,000-99,999 | 18% |
| 50,000-74,999 | 15% |
| 25,000-49,999 | 12% |
| 12,500-24,999 | 9% |
| 5,000-12,499 | 6% |

Note:
If BV/PV ratio is 3 or 3 BV (Business Volume) = 1 PV (Point Value). Therefore, full volume BV (FVB) is 450,000, while full volume PV (FVP) is 150,000. For as an example: if one BV is one Thai Baht, so full volume BV (FVB) is TUB 450,000; a production period is one month.

Each IBO starts from 0 PV with 0% performance bonus at the beginning of each production period. Bonus percentage steps up to a higher level according to total group volume PV performed by the IBO including downline in that IBO's group. When total group volume PV reaches 150,000 PV or more, that satisfies the maximum performance bonus level, is identified as achieving a full volume PV (FVP).

Herein, an IBO who attains group volume PV of at least a full volume PV, in a production period, is qualified as S1 702. S1 is a qualification that is definitely specified in Spec. 7.

Compensation formulas accompanying with various factors are disclosed above and the following values of the related factors are suggested to be used for calculation in the preferred embodiment, which also considered as the best mode, and therefore, are not considered as a limitation of the invention.

Suggested values of the factors used in the best mode are: f₁=⅔, f₂=1, f₃=½, f₄−1, f₅−1, f₆=½, f₇=1, f₈=100, f₉=1, f₁₀=1, f₁₁=1, f₁₂=1, f₁₃=1, f₁₄=1, f₁₅=½, fᵢₙₜₑᵣ=⅓, f_{foster}=⅔, and fᵢₙₜₑᵣ+_{foster}=1.

The Examples with Calculation Methods

The following examples are illustrated, together with calculation steps, on the purposes of demonstrating methods of the embodiment, and are not, therefore, considered as a limitation of the invention.

FIG. 12 shows a qualification of B1 as a calculated result. An IBO 1201 who sponsors two qualified legs of S1, and attains a side volume of at least one-third of full volume PV 1202; by Math. 1, BP=f₁(S−P)+f₂X/Y=⅔(2-1)+1×⅓=1, where: S=1+1=2, from two legs of S1; LP of each leg=1; and P=f₄(f₅H−N+2)=1(1×1−2+2)=1, f₁=⅔, f₂=1, f₄=1, f₅=1. So, the IBO achieves B1.

Depth Point by Math. 5, DP=f₆H=½×1=0.5, where H=1, f₆=½. Business Scores by Math. 6, BS=f₈(BP+f₉ DP)=100×(1+1×0.5)=150, where BP=1, DP=0.5, f₈=100 and f₉=1. Therefore, the IBO 1201 qualifies as B1, attaining Depth Point of 0.5 and Business Scores of 150.

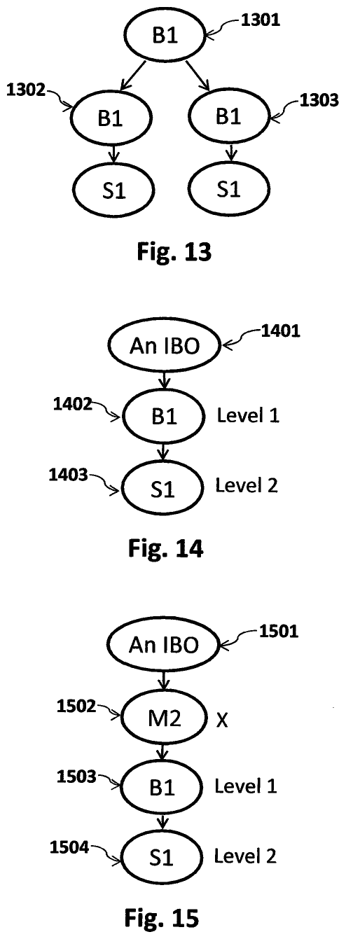

FIG. 13 shows another calculated result of B1. An IBO 1301 who sponsors two legs of at least B1 1302, 1303 by Math. 1, BP=f₁(S−P)+f₂X/Y=⅔(3−1.5)+0=1, where S=1.5+1.5=3, LP of each leg=1.5, as LP=Σf₃^{(k-1)}Dₖ(½)⁽¹⁻¹⁾(1)+(½)⁽²⁻¹⁾(1)=1.5, P=f₄(f₅H−N+2)=1(1×1.5−2+2)=1.5, f₁=⅔, f₂=1, f₃=½, f₄=1, f₅=1. Depth Point of B1 1301 by Math. 5, DP=f₆H=½×1.5=0.75, so, Business Scores of B1 1301 by Math. 6, BS=f₈(BP+f₉DP)=100(1+1×0.75)=175.

FIG. 14 and FIG. 15, show that there are two levels of 1-point qualification 1402, 1403 in FIGS. 14 and 1503, 1504 in FIG. 15, with a notice that M2 1502 as a mid-qualification (or any other pre-qualification or mid-qualification) is not counted as a level of 1-point in a qualified leg with B1 or S1 (FIG. 15).

To determine Leg Point (FIG. 15), as a qualified leg with M2 1502, B1 1503 and S1 1504 in the same line in depth as shown, it could be two options: (i) one level of M2, LP=1+Σf₁₅^{k}Eₖ=1+(½)¹×½=1.25, by Math. 16; or (ii) two levels of 1-point of B1 and S1, LP=Σf₃^{(k-1)}Dₖ=1.5, by Math. 3. Therefore, Leg Point of this leg is calculated as 1.5 points of a higher one.

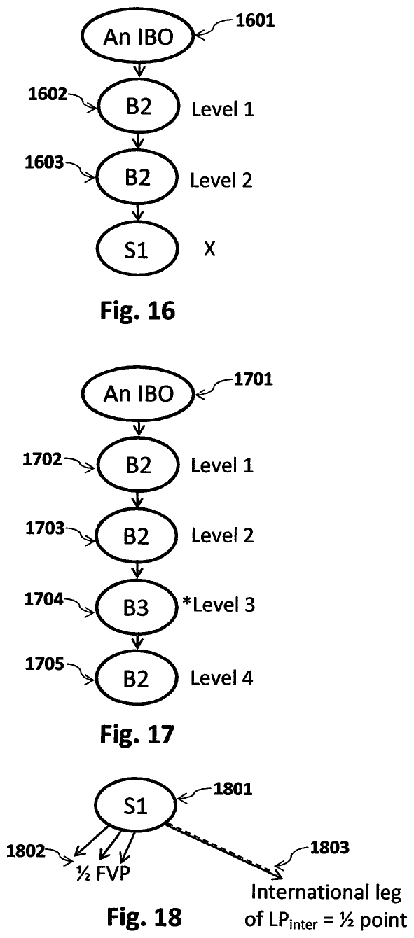

FIG. 16 shows of a qualified leg of two levels of B2 1602, 1603. Leg Point is: LP=Σf₃^{(k-1)}Dₖ=(½)⁽¹⁻¹⁾(2)+(½)⁽²⁻¹⁾(2)=3, where Dₖ=2, f₃=½ and k=2.

In FIG. 17, there are two options to calculate Leg Point: one level of B3 1704 with LP=3, or four levels of B2. It is notice that B3 1704 as a higher qualification of 3 points, when calculated in B2-leg, it is used only 2 points the same as B2. So, LP=Σf₃^{(k-1)}Dₖ.=(½)⁽¹⁻¹⁾(2)+(½)⁽²⁻¹⁾(2)+(½)⁽³⁻¹⁾(2)+(½)⁽⁴⁻¹⁾(2)=3.75, where Dₖ=2, f₃=½, and k=4. Therefore, LP of this leg is 3.75 points.

FIG. 18 shows that an IBO 1801 who attains at least a half of full volume PV 1802, of group volume PV, locally, and at least a half point of international leg (LPᵢₙₜₑᵣ=½) 1803, becomes at least one base point. So, the IBO achieves S1 1801 by one base point.

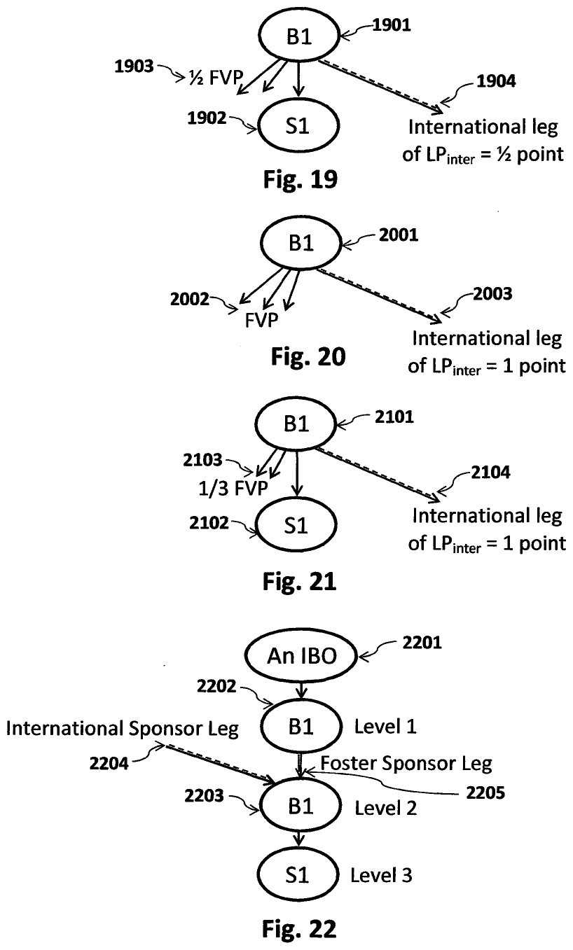

FIG. 19 shows an IBO 1901 sponsors a qualified leg of at least S1 1902 and attains at least a half of FVP of side volume PV 1903 and at least a half point of international leg (LPᵢₙₜₑᵣ=½) 1904, becomes as at least a full volume PV, the IBO achieves B1 1901 by definite specification methods.

FIG. 20 shows an IBO achieves B1 2001, who attains at least a full volume PV locally 2002, and earns at least one LP of international leg (LPᵢₙₜₑᵣ=1) 2003. FIG. 21 shows an IBO achieves B1 2101, who sponsors a qualified leg of at least S1, locally 2102, with at least one LP of international leg (LPᵢₙₜₑᵣ=1) 2104, and attains side volume PV of at least one-third of FVP 2103, (by Math. 1).

FIG. 22 shows an international sponsor leg 2204 and a foster sponsor leg 2205 in a local structure of foster sponsor. It is shown that, B1 2203 of Level 2 and downline from Level 2, have supports from two lines of sponsorship, internationally and locally. Calculations are: LPᵢₙₜₑᵣ=f₁₀fᵢₙₜₑᵣLP=1×⅓×1.5=0.5, and LP_{foster}=f₁₀f_{foster}LP=1×⅔×1.5=1. And therefore, Leg Point with reference to the IBO 2201 becomes 1.5 points (instead of 1.75 points, if calculated without sharing LP with international sponsor).

FIG. 23 shows a leg qualified of M3 2302, M4 2303, M4 2304 and at least S1 2305, in the same line in depth. In this case, an extra formula [Math. 16] is applied to calculate Leg Point. M3 and M4, both are specified as mid-qualifications with Eₖ=⅔. Therefore, LP=1+Σf₁₅^{k}Eₖ=1+(½)⁽¹⁾(⅔)+(½)⁽²⁾(⅔)+(½)⁽³⁾(⅔)=1.583333. So, Leg Point of this leg is 1.583333 points.

FIGS. 24a and 24b show a comparison between a traditional compensation method compared with the embodiment of this invention of the same structures and the same business sizes.

FIG. 24a shows that sponsoring three qualified legs in the traditional plan, is classified and recognized as C3, even though, that C3 2401 sponsors three super legs (a total PV of 3×3×21×150,000=28,350,000 PV or more), while C3 2402 sponsors three big legs (a total PV of 3×21×150,000=9,450,000 PV or more), and C21 2403 sponsors 21 qualified legs of at least S1 (a total PV of 21×150,000=3,150,000 PV or more).

In the preferred embodiment, the calculated results show that an IBO who sponsors three super legs as shown, qualifies as B28 2404. While an IBO who sponsors three big legs as shown, qualifies as B19 2405 and an IBO who sponsors 21 qualified legs of at least S1, qualifies as B14 2406.

The calculations are as the followings: an IBO who sponsors 21 qualified legs of at least S1 qualifies as B14 2406: BP=f₁(S−P)+f₂X/Y=⅔(21−0)+0=14, where: S=21×1=21, P=f₄(f₅H−N+2)=1×(1×1−21+2)=−18=0 (as P<0). The B30 who sponsors three legs of B14 qualifies as B19 2405: BP=f₁(S−P)+f₂X/Y,=⅔ (42−13)+0=19 (rounding-down), where: S=3×14=42, P=f₄(f₅H−N+2)=1×(1×14−3+2)=13.

The IBO who sponsors three legs of B19 2405 qualifies as B28 2404: BP=f₁(S−P)+f₂X/Y=⅔(63−20)+0=28 (rounding-down), where: LP=Σf₃^{(k-1)}Dₖ=(½)⁽¹⁻¹⁾(14)+(½)⁽²⁻¹⁾(14)=21 (as 2 levels of B14 or above), S=3×21=63, P=f₄(f₅H−N+2)=1×(1×21−3+2)=20, (where: f₁=⅔, f₂=1, f₃=½, f₄=1, f₅=1).

B14 2406 attains Depth Point, DP=f₆ H=½×1=0.5, and Business Scores, BS=f₈(BP+f₉ DP)=100×(14+1×0.5)=1,450. B19 2405 attains Depth Point, DP=f₆H=½×14=7, and Business Scores, BS=f₈(BP+f₉DP)=100×(19+1×7)=2,600. And B28 2404 attains Depth Point, DP=f₆H=½×21=10.5, and Business Scores, BS=f₈(BP+f₉DP)=100×(28+1×10.5)=3,850.

It can be summarized from the calculation results that, in the preferred embodiment (FIG. 24b), the 1730 who sponsors 3 super legs with a total PV of at least 28,350,000 PV as shown, deserves for a qualification of B28 2404 with Business Scores of 3,850; the IBO who sponsors 3 big legs with a total PV of at least 9,450,000 PV as shown, deserves for B19 2405 with Business Scores of 2,600; and B14 2406 who sponsors 21 legs of at least S1 with a total PV of at least 3,150,000 PV deserves for Business Scores of 1,450.

### CONCLUDING REMARKS

This invention solves significant technical problems of the traditional network marketing compensation methods and develops a brand-new “Team-up” compensation plan by using the inventive methods of definite specification and/or definite computation with the compensation formulas.

Novelty of this invention that overcomes prior art is shown by said system and methods that precisely identify or determine compensations to be paid to IBOs according to real business production they performed with fairness as well as awareness of sustainability of long-term and limitless growth of the business program, while avoiding imbalanced compensation payouts which induce conflicts among IBOs within the same line of sponsorship.

Furthermore, as shown above, steps of invention are disclosed in the manner that the persons who skilled in this industry are able to follow and apply. And lastly, it is expected that this invention shall certainly benefit directly to most network marketing companies as well as millions of people involved in this industry around the world.

### CITATION LIST

### Patent Literature

PTL1: U.S. Pat. No. 8,666,838 B2 March/2014 Bamborough et al.
PTL2: U.S. Pat. No. 8,732,012 B2 May/2014 Barnett et al.
PTL3: U.S. Pat. No. 8,423,438 B2 April/2013 Barrett
PTL4: U.S. Pat. No. 7,584,118 B1 September/2009 Bellare et al.
PTL5: U.S. Pat. No. 6,581,041 B1 June/2003 Canney
PTL6: U.S. Pat. No. 7,949,577 B1 May/2011 Cooper et al.
PTL7: U.S. Pat. No. 8,571,944 B2 October/2013 Frascino
PTL8: U.S. Pat. No. 6,421,648 B1 July/2002 Gagnon et al.
PTL9: U.S. Pat. No. 9,530,150 B2 December/2016 Goldberg et al.
PTL10: U.S. Pat. No. 6,636,852 October/2003 Gozdeck et al.
PTL11: U.S. Pat. No. 6,055,511 April/2000 Luebbering et al.
PTL12: U.S. Pat. No. 8,412,629 B2 April/2013 Masi
PTL13: U.S. Pat. No. 7,359,871 B1 April/2008 Paasche et al.
PTL14: U.S. Pat. No. 7,548,877 B2 June/2009 Palazzo
PTL15: U.S. Pat. No. 6,618,706 B1 September/2003 Rive et al.
PTL16: U.S. Pat. No. 7,149,707 B2 December/2006 Scoble
PTL17: U.S. Pat. No. 8,527,319 B2 September/2013 Shinkawa
PTL18: U.S. Pat. No. 5,819,231 October/1998 Tremaine
PTL19: U.S. Pat. No. 8,805,719 B2 August/2014 Tyler et al.
PTL20: US 2005/0222967 A1 Adir
PTL21: US 2008/0281681 A1 Bremner et al.
PTL22: US 2014/0316871 A1 Campbell et al.
PTL23: US 2006/0095319 A1 Cardwell
PTL24: US 2003/0126007 A1 Pavone et al.
PTL25: US 2002/0198779 A1 Rowen et al.
PTL26: US 2012/0010926 A1 Urso
PTL27: US 2004/0158537 A1 Webber et al.
PTL28: WO 2016/003124 A1 Han
PTL29: WO 2016/067221 A2 Merritt
PTL30: WO 2006/113049 A2 Moc

### Non Patent Literature

NPL1: Amway Business Reference Guide, 2017, Updates: Amway.com/BRG.
NPL2: Coughlan, A. T., Grayson, K., Network Marketing Organizations: Compensation Plans, Retail Network Growth, and Profitability, Intern. J. of Research in Marketing 15(1998) 401-426.
NPL3: Gregor, B., Wadlewski, A. A., Multi Level Marketing as A Business Model, Marketing of Scientific and Research Organizations, 1(7)/2013.

The invention claimed is:

1. A system with definite specification methods or definite computation methods by using compensation formulas to identify or determine bonuses or benefits to be paid to customers or distributors or independent business owners (IBOs) enrolled in retail customer referral programs or network marketing or multi-level marketing programs, said bonuses including: Business Post bonus, Depth Point bonus or Business Scores bonus, based on business production in a production period; said system further including methods to identify or determine: Business Post (BP), Leg Point (LP), Depth Point (DP), or Business Scores (BS).

2. The system of claim 1, further including the uses of definite specifications, that satisfy the conditions in a corresponding production period, comprising:
Business Post of one (1 BP or B1), definitely specified as a business size or a qualification of an IBO, achieving of sponsoring at least a qualified leg of S1 or above, and attaining side volume PV of at least a full volume PV;
Business Post of two (2 BP or B2), or above, definitely specified as a business size or a qualification of an IBO, achieving of sponsoring at least a qualified leg of S2 or B2, or above, and attaining side volume PV of at least two times, or above, of full volume PV, correspondingly;
S1 definitely specified as a qualification of an IBO who attains group volume PV of at least a full volume PV; S1 is counted as a base point of at least one point;
S2, or above, definitely specified as a qualification of an IBO who attains group volume PV of at least two times, or above, of full volume PV; S2, or above, is counted as at least two base points, or above, correspondingly;
P1 definitely specified as a qualification of an IBO who sponsors a qualified leg of S1 or above;
P2 definitely specified as a qualification of an IBO who sponsors a qualified leg of S1 or above, and attains side volume PV of at least one-twelfth of full volume PV; equivalent side volume PV fractions or Eₖ of P2 is 1/12;
P3 definitely specified as a qualification of an IBO who sponsors a qualified leg of S1 or above, and attains side volume PV of at least one-sixth of full volume PV; Eₖ of P3 is ⅙;
M1 definitely specified as a qualification of an IBO who sponsors a qualified leg of S1 or above, and attains side volume PV of at least one-third of full volume PV; Eₖ of M1 is ⅓;
M2 definitely specified as a qualification of an IBO who sponsors a qualified leg of S1 or above, and attains side volume PV of at least a half of full volume PV; Eₖ of M2 is ½;
M3 definitely specified as a qualification of an IBO who sponsors a qualified leg of S1 or above, and attains side volume PV of at least two-thirds of full volume PV; Eₖ of M3 is ⅔;
M4 definitely specified as a qualification of an IBO who sponsors two qualified legs of S1 or above, but not yet achieves B1; Eₖ of M4 is ⅔.

3. The system of claim 1 or claim 2, further including the uses of specific compensation formulas, that satisfy the conditions in a corresponding production period, comprising:

| | | |
|---|---|---|
| BPB = r₁ BP; | DPB = r₂ DP; | BSB = r₃ BS; |
| BP = f₁ (S − P) + f₂ X/Y; | S = ΣLPᵢ; | LP = Σf₃^{(k -} ¹⁾ Dk; |
| P = f₄ (f₅ H − N + 2); | DP = f₆ H; | BS = f₈ (BP + f₉ DP); |

where: P= or >0, if P<0, let P=0; DP< or =f₇ BP, if DP>f₇ BP, let DP=f₇ BP; BPB is Business Post bonus; DPB is Depth Point bonus; BSB is Business Scores bonus; BP is Business Post, in rounding-down integer; DP is Depth Point; BS is Business Scores; LPᵢ is Leg Point of each qualified leg; Dₖ is Business Post or base point of the same point or above, of each level in the same line in depth of a qualified leg, by using the same point in calculation; S is sum of Leg Point of all qualified legs; P is parameter; H is the highest Leg Point of the largest leg of an IBO as calculated; N is number of qualified legs of an IBO with two legs or more; X is side volume PV, excluding qualified leg(s); Y is a full volume PV of performance bonus schedule; r₁, r₂, r₃ are payout rates; and f₁, f₂, f₃, f₄, f₅, f₆, f₇, f₈, f₉ are control factors.

4. The system of any one of claims 1 to 3, applying for international and foster sponsor business or cross-structure business, further including modified compensation formulas, comprising:

| | | |
|---|---|---|
| LP_{foster} = f_{foster} LP; | LPᵢₙₜₑᵣ = f₁₀ fᵢₙₜₑᵣ LP; | BP_{foster} = f_{foster} BP; |
| BPᵢₙₜₑᵣ = f₁₁ fᵢₙₜₑᵣ BP; | DP_{foster} = f_{foster} DP; | DPᵢₙₜₑᵣ = f₁₂ fᵢₙₜₑᵣ DP; |
| BS_{foster} = f_{foster} BS; | BSᵢₙₜₑᵣ = f₁₃ fᵢₙₜₑᵣ BS; | BP = f₁ (S −P ) + |
| | | f₂ X/Y + f₁₄ LPᵢₙₜₑᵣ |

in the case of LPᵢₙₜₑᵣ is less than one, of international sponsor portion;
where: fᵢₙₜₑᵣ is international business factor, f_{foster} is foster business factor; f₁₀, f₁₁, f₁₂, f₁₃ and f₁₄ are adjustment factors; subscript “foster” stands for “foster leg” and subscript “inter” stands for “international leg”.

5. The system of any one of claims 1 to 4, further including methods to identify an IBO's business into three categories, comprising: (i) an IBO with no qualified leg, wherein, traditional performance bonus applied; (ii) an IBO who attains one qualified leg, herein, definite specification methods primarily applied; or (iii) an IBO who attains two qualified legs or more, herein, specific compensation formulas applied.

6. The system of claim 5, further including methods to identify a qualified leg into two categories, comprising: (i) a qualified leg of S-leg which qualified of at least S1, without qualification of B1 or above in that leg, herein, Leg Point of S-leg definitely specified as X1/Y, where: X1 is group volume PV of S1 or above, and Y is a full volume PV; or (ii) a qualified leg of B-leg which qualified of at least B1 in that leg, herein, Leg Point of B-leg determined by using specific compensation formulas of claim 3.

7. The system of claim 6, further including methods to identify a qualified leg as multiple levels in the same line in depth of the same point or above, by using the same point in calculation; whereas, if there are more than one option in calculation, a result of the highest point is counted as Leg Point of that leg.

8. The system of claim 6 or claim 7, further including methods to determine Leg Point of a qualified leg with qualifications of P2, P3, M1, M2, M3 or M4; by using an extra formula, herein: LP=1+Σf₁₅^{k}Eₖ; where: Eₖ is equivalent side volume PV fractions, in each levels in the same line in depth of the same fractions or above, by using the same fractions in calculation, and f₁₅ is a control factor.
